(19) United States
(12) Patent Application Publication
(10) Pub. No.: US 2018/0339942 A1
(43) Pub. Date: Nov. 29, 2018

(54) Pozzolan Polymer Modified Portland Cement Bound Graphite Composition of Matter

(71) Applicant: James Edward Hilliard, Jacksonville, FL (US)

(72) Inventor: James Edward Hilliard, Jacksonville, FL (US)

(21) Appl. No.: 15/961,875

(22) Filed: Apr. 25, 2018

Related U.S. Application Data
(60) Provisional application No. 62/511,710, filed on May 26, 2017.

(51) Int. Cl. C04B 7/02; C04B 14/14; C04B 14/06; C04B 14/04; C04B 14/02; C04B 40/00

(52) U.S. Cl. CPC C04B 7/02; C04B 14/14; C04B 14/06; C04B 2111/00482; C04B 14/024; C04B 40/0039; C04B 14/044

(57) ABSTRACT

A composition of matter for use as an electrode in batteries, fuel cells and other applications, that may or may not be primarily composed of graphite, Portland Cement, pozzolans and water. Organic polymers, additives, reinforcements, fillers, catalysts, current collectors, and other materials may be included in vast ranges and proportions. Large graphite electrodes and other useful products are fabricated integrating concrete with chemical and electrical sciences. Batteries, fuel cells, thermal energy systems, conductive paints, fireproof coatings, metal casting forms, crucibles, fire bricks, graphite electrodes for electroplating, electric arc furnaces, and other applications may make use of the composition. For example, an air battery cathode composed of 50 grams white portland cement, 7 grams metakaolin pozzolan, and 700 grams of properly mixed graphite particle sizes. Dry components mixed with a water based liquid component start the cementing reactions. Mixing, forming and curing play important roles in the final composition properties.

### CROSS-REFERENCE TO RELATED APPLICATIONS

Provisional Application: 62/511,710

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

This invention relates to a new cementitious composition that can be used to bind graphite and/or other materials for use as electrodes, conductors, thermal energy systems and other uses. The unsolidified, freshly mixed composition may be similar to concrete or paint, depending on the design. The description of the composition of matter contained in this application discusses a few of the uses of the final solidified composition, but the potential uses for this solid graphite composition are the same as all current applications utilizing graphite forms (rods, plates, films, crucibles, blocks, etc.) with many new abilities including, but not limited to the ability to mix electrolytes, catalysts and other additives homogeneously into an electrode's solid, 3D matrix before the material solidifies. In addition the composition can be designed for structural properties required in civil infrastructure, like concrete. Electroplating, electric arc furnaces, graphite molds, foundry coatings, fire proof coatings, conductive coatings, grounding rod replacements and many other industries around the world will be able to take advantage of this unique, yet simple discovery in addition to the uses described in the embodiments.

### FIELD OF THE INVENTION

This invention relates to a new cementitious bound graphite composition, modifications to the composition to enhance desired traits and the potential uses of the discovery.

### DESCRIPTION OF RELATED ART

Graphite compositions used to create batteries and much more currently require expensive materials and manufacturing processes to fabricate.

In the past Portland cement and graphite have been mixed together to assist with creating an electrical component or battery. A battery cathode is described in Publication 11 Number U.S. Pat. No. 2,962,540 A. However, the Portland cement and graphite would fail after a short period of time. Accordingly, the Portland cement bound graphite composition would have little if any structural uses and would lose its electrical qualities when the composition fell apart.

The study of pozzolan additives to cement for concrete has progressed significantly in the time since the prior arts split from attempting to use portland cement inorganic binders to the common organic based systems such as epoxies, acrylics, PVAs and others used for battery/fuel cell/solar cell/thermal/other applications. It is now well understood that unmodified Portland Cement creates a harmful calcium hydroxide byproduct during curing. The addition of pozzolans gives the calcium hydroxide something to react with and continue forming strong cementitious bonding polymers/structures. Geopolymers use the same principles but replacements for the calcium hydroxide component can be made and refined as needed.

Contrary to the prior art, the present invention provides a cementitious composition that maintains a strong structural and electrical quality by mixing pozzolans and/or organic polymers with Portland cement and graphite. In addition additives, may be used to modify the electrical properties of the final composition and also properties of the mix after wetting and during placing or forming. A typical example would be the use of water reducers that allow concrete to flow into forms without adding more water to increase the strength of the solidified composition or the use of table salt to accelerate the hardening process and to provide internal electrolyte filled pores.

Graphite rods are very common battery elements. There currently is not an easy way to create graphite rods and the rods used in even typical D size batteries are relatively small. The ability to cast a graphite rod just like concrete, with any shape at any size, easily and relatively cost effectively, is a very unique property of this composition.

It is well understood that gradation of sand and rock in typical concrete is important for controlling the final composition and the mixing/placing phase. Extensive studies exist on the subject dating back thousands of years. The same basic concrete mix engineering principles apply when creating the composition, but the science must be integrated with energy and chemical sciences to properly design the composition of matter for an intended use (i.e. Lithium battery, Aluminum battery, Concentrated solar power, etc.)

As an example, concrete professionals use “potable water” that is filled with unknown chemicals or sands that are of an unknown composition. The second embodiment of this patent, Additives, discusses how these factors can significantly affect the overall system (i.e. battery cell) being designed.

This invention typically replaces all the “rock and sand” aggregates with a mix of graded graphite from nano and micronized particle sizes up to the full thickness of the overall composition, or as large as possible. For a concrete engineer familiar with developing ultra high performance concrete, the graphite replaces the sand and rock in concrete, and the cement content is minimized, to make the invention. Concrete water reducers, foaming agents, viscosity modifiers and the rest of the concrete industry cement modifiers can be used for desired properties of the composition, but care must be taken to integrate the electrical and chemical sciences. In addition other additives and reinforcements can be included throughout the final solid composition.

The gradation of the graphite materials, the mixing process, the forming/application process, the curing process and much more can easily be understood and manipulated for specific design purposes by concrete and epoxy composite engineers.

While the manufacturing and basic understanding of how the composition is mixed, formed and cured may be easily understood by those familiar with concrete or epoxy engineered materials, the chemical and electrical nature of the overall composition requires vast understanding of battery, fuel cell, chemistry, electrical and other sciences.

Porous electrodes for use with metal air batteries are under intense study around the world and are expected to replace many of the current battery technologies in the near future. The discovered material offers many unique characteristics that allow excellent results when properly designed for the air battery electrode application. Porosity, the size of pores and flow channels for electrolytes/fuels/ions are controlled by mix design and also by the method of manufacturing the final solid product. Pressure can be used to modify properties such porosity before the cementing process progresses past a certain point. The composition allows for mixing, extruding/forming and curing of the composite in a similar manner to concrete block or tile. Autoclaved aerated compositions can produce very porous compositions.

Zeolites and geopolymers are being studied around the globe for their interesting properties. In the fourth embodiment the patent integrates these sciences into the composition. Zeolites of hydrated aluminosilicate minerals containing alkali and alkaline metals with internal structures that enclose continuous pores filled with ion exchanging metal cations are formed that fit perfectly into the battery and fuel cell electrode sciences.

The studies around the globe on geopolymers and the use of pozzolans to replace Portland Cement in concrete are exhaustive. We know that pyramids around the world used volcanic ash as cements and today much of that same science is used for formulating pozzolan cement additives. Pozzolans most commonly used are waste products from industrial processes. An example is fly ash from coal. Unstudied are the interactions that the different pozzolans may have when used in applications made possible by the composition of matter discovered.

Although extensive prior art exists on using pozzolan modified Portland Cement for the purposes of creating concrete, nothing like the discovered composition of matter exists to make graphite electrodes or for other uses described.

It is common knowledge when working with graphite that larger particle sizes of the same materials have higher conductivity than smaller particles. Particle sizes and shapes play important roles in all aspects of the composition including mixing and forming processes. A mixture of particle sizes minimizes the void space between graphite particles and typically increases conductivity of solid compositions. By leaving out fines, the porosity of the final composition can be increased similar to the way porous concrete is made.

Graphite powders and metal oxide catalysts are well known combinations in the battery and fuel cell industries. The composition of matter discovered expands upon this vast and growing field of science with additives other than graphite.

The use of pozzolan modified cement to bind graphite and/or metal powders and oxides for use in batteries and fuel cells is unique from all known prior arts. Organic polymers used in the prior arts can be integrated with this discovery to further enhance or otherwise modify the composition.

The ability to integrate electrolytes, catalysts and other additives homogeneously throughout the final 3D graphite solid matrix using a wet mixing process, before the electrode solidifies, makes this graphite based composition of matter unique. In addition layering or forming techniques may be used to separate catalysts, filter electrolyte, or as needed for an intended design.

Graphite based electrodes for use in batteries, fuel cells, capacitors and other applications typically require expensive organic based materials and/or manufacturing processes for shaping, adhering together or adhering onto a current collector. Many patents exist and studies continue around the world using graphite plates, tubes, films and other shapes that could be made easier and more cost effective with this invention and discovery.

Portland Cement is primarily a calcium, aluminum and silicon based material. Modifying the cement composition for specific applications allows the designer to change the internal structure of the electrodes for the intended use (i.e. Lithium battery or Aluminum battery).

The required gradations of the graphite materials, mixing process, forming/application process, curing process and much more can easily be understood by concrete engineers. It is well understood that gradation of sand and rock in typical concrete is important and extensive studies exist on the subject. This invention typically replaces all the “rock and sand” aggregates with a mix of pre graded graphite particles ranging in size from micronized powders up to the full thickness of the overall final composition. For some compositions, recycled synthetic graphite from graphite electrode machining processes make great aggregate replacements. Flake graphite, natural graphite, synthetic graphite, other known graphite carbon based materials, such as carbon fibers and graphene can be integrated with the discovered composition.

Concrete application professionals familiar with exposed aggregate concrete and color hardeners will fully understand the following potential layering applications. A dry very expensive mix of the invention can be applied with a salt/pepper shaker directly over a freshly placed mix of less expense in the same way color hardeners are applied to concrete around the world.

Concrete engineers could easily make the composition of matter by using a pozzolan/energetically modified portland cement concrete with properly graded and blended graphite replacing the typical sand and rock aggregates. Chemical engineers and brilliant minds who study electrical storage and generation systems commonly called batteries or fuel cells can easily use the composition discovered and modify it to turn all conductive metallic substances known into the negative electrode of a primary battery. According to standard battery industry science the best mixes use the least amount of binder, but when the binder becomes an ionic conductive metal zeolite trap, standard industry sciences must adapt. Concrete water reducers, foaming agents, viscosity modifiers, reinforcements and the rest of the concrete industry technology can be used for enhancing such desired properties of the composition of matter being described as well as common electrolytes, catalysts, doping agents and other additives commonly used in the battery industry. In many cases extensive studies exist in the prior art of both fields using the same material. As an example: Sodium chloride based battery electrolytes and sodium chloride in concrete. Both those prior arts have been studied extensively for thousands of years.

It is also common to minimize cement to minimize costs. It is common in the concrete industry to try minimizing water to cement ratios to decrease voids and increase the final strength of the material. Adding water past a certain range during mixing increases the porosity of the invented composition. Higher porosity may be desired for some uses of this invention.

Alkali silicates, commonly used as concrete sealants, may serve the same purpose as pozzolans and can allow easy manipulation of the overall compositions individual metal (Sodium, Potassium, Lithium, etc.) contents. Sodium silicate is the most common. Pre blending dry materials, placing the dry materials and then wetting the dry, compacted/uncompacted mass with alkali silicates is an example of how to create the composition of matter being patented herein. The alkali metal silicates may be designed to participate in electrochemical reactions.

Sealants can be used to allow ionic filtering and transfers into and out of the composition of matter. For example, a typical acrylic concrete sealant mixed with aluminum chloride performs better as a secondary rechargeable aluminum battery cathode than a control sealant without the electrolyte added.

Graphite is well know as being one of the best materials for battery cathode/anode electrodes. According to most references, graphite is the highest substance on the cathodic scale/galvanic series and is considered to be the most noble substance known to exist. The binders typically used for graphite are an epoxy or other organic polymer base. Extensive study has gone into determining the absolute minimum amount of binder needed. Literature typically states around 10% for the organic binders. The organic binding systems are known for being impermeable to fluid and ionic flows. Portland cement based inorganic binding systems have different properties that may be desirable for individual applications. The percentage of binder used in the composition can vary significantly depending on the intended use, but values approaching 5% are possible. The extremely low binder percentages are possible when making this composition of matter with properly mixed graphite particle sizes. The shape of the particles may also determine workability and things such as the ability to easily fill forms or spray the wet mix.

In exactly the same way curing is important for concrete, it is vital that the composition of matter be properly cured to ensure the polymerization and cement hydration processes are completed for the intended use. Pressure, temperature, humidity and other factors play important roles during the composition process of solidifying.

Concrete is typically reinforced with steel rebar and the composition of matter current collectors could take the place of the reinforcing while serving as a stable current collector. Current collectors, if used, need to be designed for the environment they will be used in. As an example. Copper or nickel works great in certain environments. Gold or platinum may be required for others. Alloys and impermeable graphite infused polymer coatings can be used to improve current collector performance. The prior art related to this subject dates back thousands of years and is outside the scope of this application. The same way concrete engineers use “cover” over steel reinforcement or epoxy coated rebar or organic polymers to prevent rusting of the reinforcement, the composition of matter can be modified to prevent or significantly slow down current collector corrosion.

### BRIEF SUMMARY OF THE INVENTION

The composition of matter discovered makes creating air batteries using common trash metals that would otherwise need to be recycled easy and affordable on large and small scales. In addition to the being used for purposes of creating an air battery cathode there are many other uses disclosed in this invention.

The present invention may be described as a composition of graphite, Portland cement, and pozzolans, with or without organic polymers, and other additives that when mixed with a liquid component polymerize to form a solid. The liquid component can be distilled water or a solution/mixture of water and other additives as described in the Second Embodiment. In addition, current collectors are able to integrated into the forming and casting process to embed the current collectors into the solid composition.

Graphite rods, plates, films and other forms of graphite used throughout the electrical industry, that are currently expensive or difficult to make, can be formed using the discovered composition with numerous performance gains and minimal performance losses. Currently cathodes are made using expensive, dangerous or very difficult to use binders/manufacturing methods. Using the discovered composition cathodes can be mixed to mold like concrete/clay, or, by simply adding more water, the composition can create a durable paint/ink texture.

The graphite and geopolymer components are stable in extremely high heat environments. This allows the composition of matter to be designed for high temperature applications.

The compatibility of the materials used allows for layering, as well as a 2 or 3 dimensional “circuit” to be developed that is one solid unit. Solid state batteries are easily made using the invented composition of matter layering properties.

The “circuit” may be used as a cell component to convert solar light energy to electricity, for thermal electric conversion, parallel and series battery cell configurations, fuel cells, or endless other electrical components.

The composition can be modified as needed to help ensure it can withstand the environment it will be used in. In addition the pozzolanic modifiers may be designed for individual applications. As an example, metakaolin pozzolan is high in aluminum and works well for aluminum based primary and secondary battery cell cathodes. Alkali silicate materials and blends can also be used to make the composition for specific applications. For example lithium silicates, commonly used as concrete sealers, can be used for lithium metal based battery cells. Common alkali silicates include, but are not limited to lithium, potassium and sodium metal, all three of which are under extensive study for use in battery and fuel cell systems. Blends of different materials and additives are possible as described further in this application and detailed drawings.

The unique quality of the present invention is that it can withstand extreme environments while maintaining desired properties throughout a long term lifespan. The pozzolans and/or other polymers added to the mix of cement and graphite is critical to providing the materials unique qualities.

With this discovery and the compositions of matter invented, the cost of large-scale batteries and fuel cells for electrical generation and storage can be significantly reduced. Solar cells and thermal energy conversion to electricity devices can also be made using this invented material.

### BRIEF DESCRIPTION OF THE SEVERAL VIEWS OF THE DRAWING(S)

FIG. 1.0 shows a solidified composition of matter.

FIG. 1.0a shows a cross sectional view of FIG. 1.0.

FIG. 1.0b shows a cross sectional view of FIG. 1.0 that is perpendicular to the view shown in FIG. 1.0a.

FIG. 1.1 shows a solidified composition of matter with electrolyte/fuel flow “holes” integrated within.

FIG. 1.1a shows a cross sectional view of FIG. 1.1.

FIG. 1.1b shows a cross sectional view of FIG. 1.1 that is perpendicular to the view shown in FIG. 1.1a.

FIG. 2.0 shows a solidified composition of matter with a current collector embedded within it. This figure additionally shows the current collector, which has a lower electrical resistance than the composition.

FIG. 2.0a is a cross sectional view of FIG. 2.0, which shows the current collector embedded within the composition of matter.

FIG. 2.0b shows a cross sectional view of FIG. 2.0 that is perpendicular to the view shown if FIG. 2.0a.

FIG. 2.0c shows a conductor surrounded by the composition of matter to be used as a cathode or anode in a battery/fuel cell. A conductor coil is specifically shown within the composition of matter.

FIG. 3.0 shows a top, front, and right view of a composition of matter that may act as a cathode layer, anode layer, conductor protective layer, a separating layer, a blocking layer, or a bonding layer.

FIG. 3.0a is a cross-sectional view of the FIG. 3.0, which shows the added layer on top of the composition of matter and a current collector embedded within the composition of matter.

FIG. 3.0b is a cross-sectional view of FIG. 3.0, which is perpendicular to the cross-sectional view of FIG. 3.0a.

FIG. 3.1 shows a composition of matter that has multiple layers and can help take advantage of catalysts, such as, but not limited to cobalt or platinum, while reducing overall costs. As discussed on FIG. 3.0 the thickness of any given layer may be very thin.

FIG. 3.1a is a cross-sectional view of FIG. 3.1 which shows a current collector embedded between the composition of matter and a catalyzed layer. This figure shows an additional non-conductive, ion permeable layer that covers the catalyzed layer and the composition of matter that is not necessary but is possible.

FIG. 3.1b is a cross-sectional view of FIG. 3.1 which is perpendicular to the cross-sectional view shown in FIG. 3.1b.

FIG. 4.0 is the view of a battery which shows a cathode, an anode, a conductor, and an electrolyte. FIG. 4.0 also shows a positive battery terminal and a negative battery terminal.

FIG. 4.1a shows an isometric view on a negative battery terminal and a positive battery terminal, which are divided with a separating layer that permits ionic flow but does not conduct electricity. In other words, it helps to ensure that the anode and cathode do not touch and short the battery cell.

FIG. 4.1b shows a series connection in a single cell. This embodiment can be utilized in sewer systems.

FIG. 4.1c shows a battery where with multiple anode layers, multiple cathode layers, and multiple separating layers. The anode layers are connected to other anode layers with a conductor, the cathode layers are connected to other cathode layers with a conductor, and the separation layers are provided between each anode layer and cathode layer.

FIG. 4.1d shows a battery where a series of connection is provided between two battery cells. It is anticipated that additional battery cells can be added to the series.

FIG. 5.0 shows the embodiments arranging a fuel cell in a pipe configuration.

FIG. 5.1 shows the embodiments arranging a fuel cell in a drainage ditch configuration.

FIG. 6.0 shows a composition of matter used for thermal energy transfer.

FIG. 7.0 shows an example of how the composition of matter described herein can be arranged to be a solar cell.

FIG. 7.0a is a cross-sectional view of FIG. 7.0.

### NUMBER REFERENCES

5—Composition of Matter
10—Current Collector
15—Protective Layer/Separation Layer
20—Catalyzed Layer
25—Non-Catalyzed Layer
30—Cathode
35—Anode
40—Electrolyte
45—Negative Terminal
50—Positive Terminal
100—Concrete Pipe
150—Concrete Drainage Ditch
200—Water Heater
300—Solar Panel

### DETAILED DESCRIPTION OF THE INVENTION

The present invention is a composition of matter which is comprised of graphite, Portland cement, and pozzolans. Additional additives, including organic polymers can be added to improve desired performance. When water or a water based liquid component is added to the composition, mixed, placed, and cured the material becomes solidified. Although the material is solidified, a plurality of pores are provided within the material.

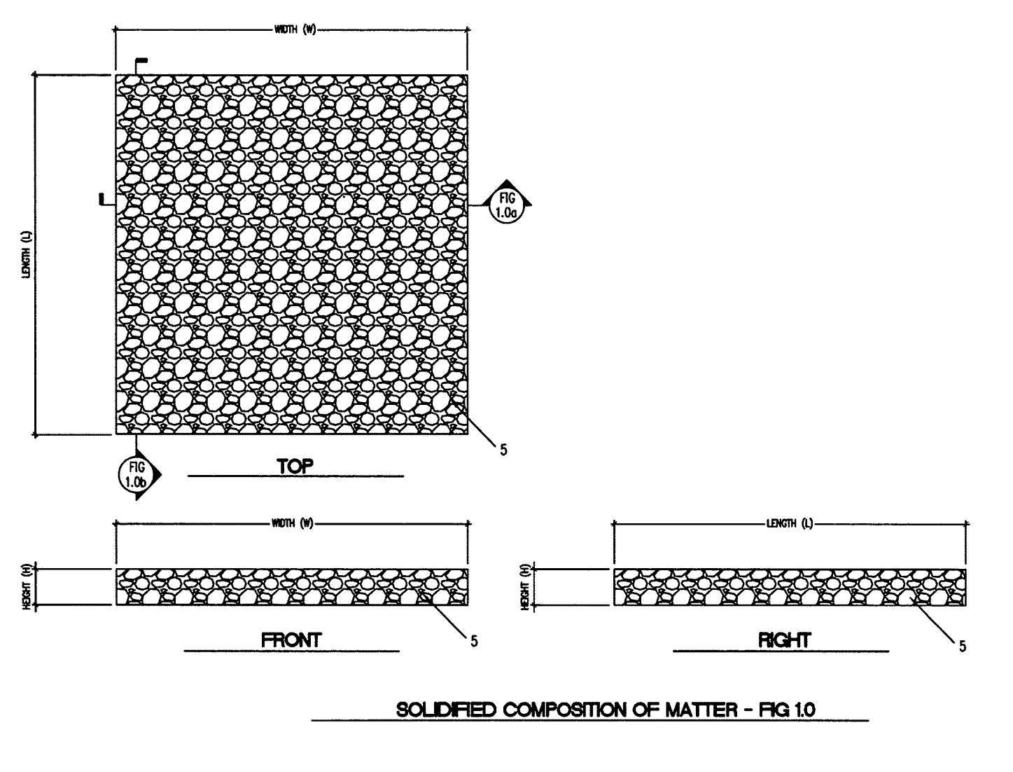

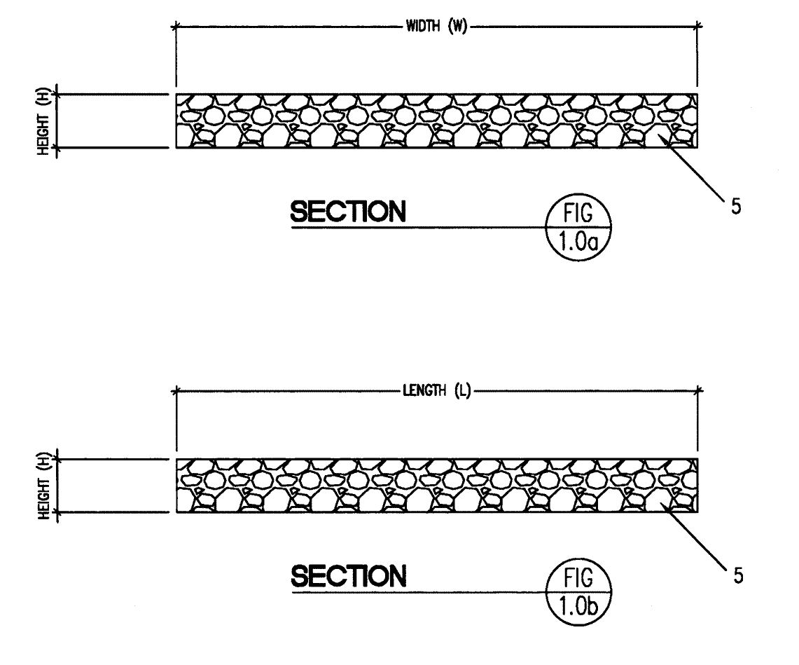

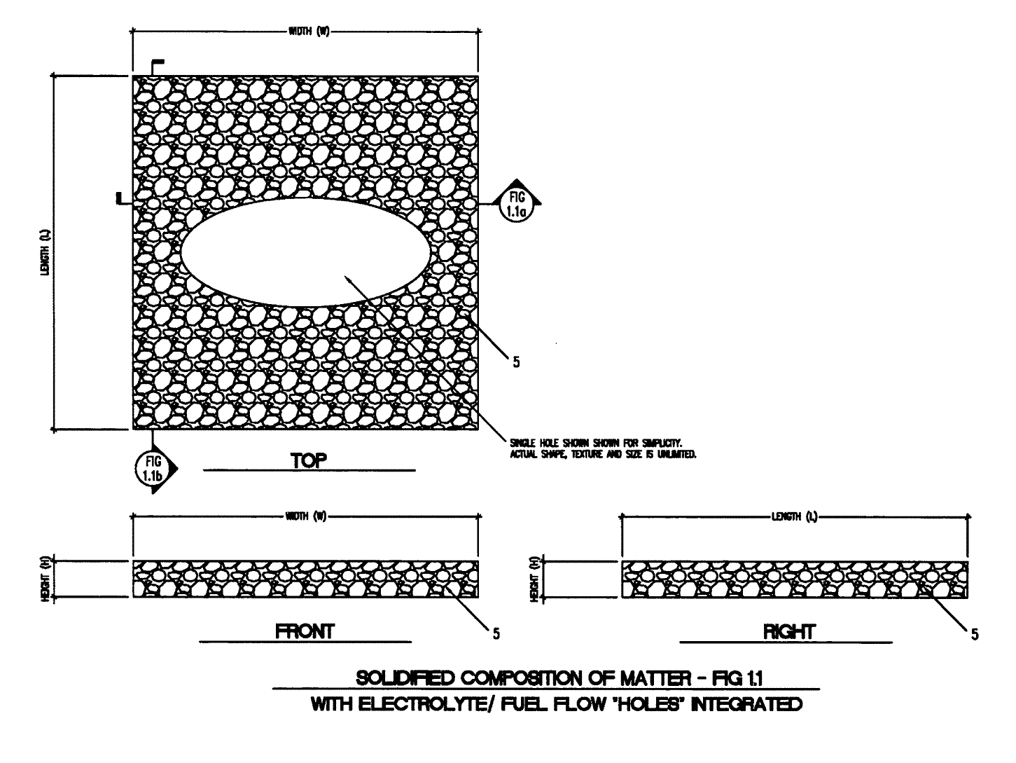

The presently described composition of matter may be looked at on a macro, micro, nano, or angstrom level. The labeled width, height and length of the invented composition of matter shown in FIG. 1.0, FIG. 1.0a, and FIG. 1.0b could also be labeled using conventional calculus and mathematics such as, but not limited to x, y, z or dx, dy, dz where it may represent a infinitesimally small part of a larger surface or volume and not the overall measurement for the entire composition of matter.

Variances in the mix design or designs significantly influence properties including structural strength, durability, cathodic and/or anodic potential, conductivity/resistance, band gaps, other electrical and magnetic properties, porosity, permeability, future maintenance, multi-layer binding strengths, workability, binding strength, and more.

The composition of matter can be cast into forms just like concrete and can be thinned with water, or other using other methods, down to a thin paintable/sprayable/dipping liquid. Enhancements using heat treatments, pressure and enhanced curing techniques are possible. Manufacturing of graphite based electrodes in forms just like concrete blocks and structures is a unique property of this discovery, but easily overlooked is the ability to quickly dip anything into a liquid form of the composition that then hardens into a cementitious bound, durable surface.

### 2 EXAMPLE OF USE

These are 2 of infinite examples and are intended to show very simple uses of the discovery.

### Example One

An aluminum battery recycling trash can is easily formed by creating a large graphite cathode using the discovered composition of matter described in the patent application embodiments.

The trash can is a large cathode covered in a separating layer. Electrolyte is contained within where trash aluminum is thrown away. This effectively creates a battery with a theoretical voltage around 1.2. The voltage, current, and rate of power depend on electrolytes and many other factors. 10 trash cans, connected in series, creates approximately 12 volts. 100 trash cans would create 120 volts. Enough to significantly injure or possible kill.

### Example Two

A large scrap aluminum block is first dipped into a thick liquid of mechanically blended 50% water, 50% cement by weight cement mixture. The layer of cement and water are allowed to cure and create a separation layer for anode and cathode. Multiple dips/coats may be used. Next the coated aluminum block is dipped and coated using the composition of matter discovered without any additives. Care is taken to ensure a short between the anode and cathode is not created so that a useful primary aluminum battery is created. Simply connect to the aluminum anode and the graphite cathode. If measures are not taken to ensure that electrolytes remain in the pores and the system is allowed to dry out, thereby stopping all oxidation reactions at the aluminum anode, the battery will not produce a current. The battery can be “turned back on” by simply wetting with electrolyte or water due to the compositions inherent porosity.

The composition of matter can be designed for extreme chemical environments, to pass very high currents and massive amounts of electrical power, with high structural strength, to maximize desired electrical and redox properties, and for any combination of such along with other factors. Aqueous or water based electrolytes ranging from low pH acids to the highest pH bases work well. Other battery industry/fuel cell, and oftentimes very dangerous electrolyte chemistries work well with a properly prepared, such as thoroughly dried, solid composition of matter.

This invention can be described in seven embodiments. The present embodiments are specific descriptions for easier understanding of the gist of the present invention and should not limit the present invention. The first embodiment is a solid novel and unique cementitious composition of matter created by mixing dry components with wet components that polymerize/hydrate to otherwise become a solid homogeneous structure. The second embodiment includes additives. The third embodiment discloses a Portland Cement geopolymer hybrid composition of matter. The fourth embodiment is a modified version of the first embodiment that provides an integrated current collector. The fifth embodiment discloses that the composition of matter can be layered. The sixth embodiment discloses the use of the composition for battery and fuel cell systems. The seventh embodiment discloses a few of the other potential uses for the composition including solar cells, coatings, thermal and other energy harvesting systems.

### First Embodiment

### Base Composition

The first embodiment teaches a composition of matter that is comprised of Portland cement, pozzolans, and graphite. The Portland cement, pozzolan, and graphite powder are mixed together in water. A typical mix described in the first embodiment are comprised of 100 grams of White Portland cement, 15 grams of a pozzolan compound, 1150 grams of mixed synthetic graphite particle sizes (75 grams 325 mesh, 400 grams mason sand particle distribution, 675 grams % ⅜″ max size “rock”), and water as needed.

The pozzolan compound may be fly ash, silica fume, a liquid based alkali metal silicate, metakaolin, or other pozzolan materials that react with calcium hydroxide or metal hydroxide additives to form calcium and other metal silicate based hydrates.

Portland cement comes in many blends and types, some with pozzolans already added to the mix. Using white portland cement helps to minimize iron oxides and other possible unknown contaminants in the portland cement. For sake of science contaminants in the Portland Cement may be analyzed as additives as described in the embodiments.

This embodiment is shown in FIG. 1.0, FIG. 1.0a, and FIG. 1.0b.

Fuel/electrolyte flow holes can be provided within the composition of matter, which is shown in FIG. 1.1. The fuel flow hole shown in the FIG. 1.1 is not limited to the size or shape shown.

The first embodiment also teaches a composition of matter that is comprised of Portland cement, pozzolans, and additives other than graphite, such as anodic materials or cathode catalysts, for use in battery/fuel cell/thermal/solar/other applications. The Portland cement, pozzolan, and additives are mixed together in water with or without graphite included. An example mix is comprised of 100 grams of White Portland cement, 15 grams of a pozzolan compound, 1150 grams of aluminum with varying particle sizes (75 grams 325 mesh, 400 grams mason sand particle distribution, 675 grams % ⅜″ max size “rock”), and water as needed. Small amounts or large amounts of graphite may be added to improve conductivity during use. The mix described could be used as an anode for the first mix described in this Embodiment to create a battery.

### Second Embodiment

### Additives

This second embodiment discloses the composition of matter wherein an additive is included in the mix to enhance a desired property. Mixes may be designed using any combination of additives. Additives used may be standard in the concrete industry to enhance certain properties and/or they may be standard additives in the battery and electrical industries. As an example, adding sodium hydroxide, a common battery electrolyte, to the mix decreases curing time by promoting faster polymerization of the composition of matter and can enhance desired properties for electrical applications or where high heat resistance is desired. The metal hydroxide additives allow pozzolan loads to increase by making up for the lack of calcium hydroxide Portland cement byproducts and allow the internal chemical structure of the composition to be adjusted as needed.

High range water reducers used around the world for concrete improve strength, durability, and chemical resistance of the invention and have a significant role on the compositions electrical and chemical properties. Cobalt, as well as manganese, their compounds, and other metals or oxides are compatible additives for the composition described in the first embodiment.

Any compatible substance may be used as an additive to modify overall composition properties as needed. Catalysts and doping agents compatible with the composition of matter may also be included in an infinite array of ratios to create a desired electrode or other design. Fiberglass fibers are an example of an additive that may serve two purpose, enhancing strength and modifying capacitance.

The composition properties are easily manipulated using fillers or additives. Band gaps, cathodic/anodic properties, conductivity/resistance, capacitance, and other electric and magnetic properties. All known graphite and carbon types can be used and mixed together to create the composition of matter.

Graphite is a cathodic substance, but when graphite powder is mixed with aluminum powder, the overall mixture becomes more anodic depending on the amount of aluminum. Carbon powders are conductive, but do not have the cathodic strength of graphite and may be used as an additive to replace graphite which can further push the composition toward the anodic side of the scale, changing the electrode potential. Numerous additives may be able to replace graphite depending on the designed use.

As an example of graphite being used as an anode: Asbury Carbons sells “Anodic Graphite Backfill” that uses graphite for conductivity while providing an anodic metal (probably zinc or aluminum) source for oil pipeline cathodic protection measures. The anodic graphite backfill using the pozzolan and/or polymer modified cement as a binder creates the “doped” invention described here in. The composition obtains anodic properties relative to a more cathodic composition such as an undoped synthetic graphite based material described in embodiment one. Separated by electrolyte, the two create a battery.

Adding common sands, reinforcements and aggregates can modify expenses, structural, thermal, electrical, and other properties. Adding common clays (sometimes also called pozzolans) and heat treating the compositions outside of concrete industry norms similar to clays can also create amazing properties with very different traits than the non heat treated.

Quartz based aggregates (sand and rock), granite based aggregates, and others typically found in concrete mixes cause tremendous variance in the properties of the overall composition. As an example, capacitance may improve with some aggregates, battery energy storage may improve with others.

In some instances, such as when bonding two compositions together, organic polymers may be helpful in addition to pozzolans. Organic polymers can also reduce the permeability of the composition as needed for design purposes. Extensive studies exist on the use of different organic polymers that may be used to bind graphite and most of the known science can be integrated with the composition of matter described in the embodiments.

Additives may also be integrated into mixing liquid. Electrolytes compatible with being added to the wet component of the mix should be considered a composition additive.

Reinforcements integrated into the mixtures and other embodiments described should be considered an additive.

Using pure graphite, minimizing cement content, and minimizing contaminants creates an undoped composition without additives for control comparison.

An example of what may be analyzed as additives would be an increased loading of Portland cement, geopolymers, or organic binders relative to graphite or catalysts. Conductivity changes and electrode potential changes can be modified for specific applications using additives or changes in the proportions of each composition constituent. The conductive and affordable composition has very interesting properties that can be refined with additives and reinforcements.

An example of such a mix would be 450 grams of white Portland cement, 50 grams of metakaolin pozzolan, 500 grams of 325 mesh synthetic graphite dust, and 400 grams of 0.7% NaOH to distilled water solution.

### Third Embodiment

### Geopolymer

This third embodiment is described as a Portland Cement Geopolymer hybrid composition of matter. In addition to the compounds mentioned in the first embodiment, this hybrid composition adds metal hydroxides, increases pozzolan loadings, and decreases portland cement contents. Alkali metal silicates may also be added. This provides many benefits shared with a geopolymer composition at a fraction of the cost, without the extreme caustic substance issues and allows for the use of standard concrete practices when working with the material during mixing and curing.

It has been discovered that cementing systems can be formulated for specific designs to completely replace all Portland Cement with pozzolanic materials and non organic activators/additives. Many concrete and cement industry studies relate cost savings with pozzolan replacements for Portland cement.

### Fourth Embodiment

### Current Collector

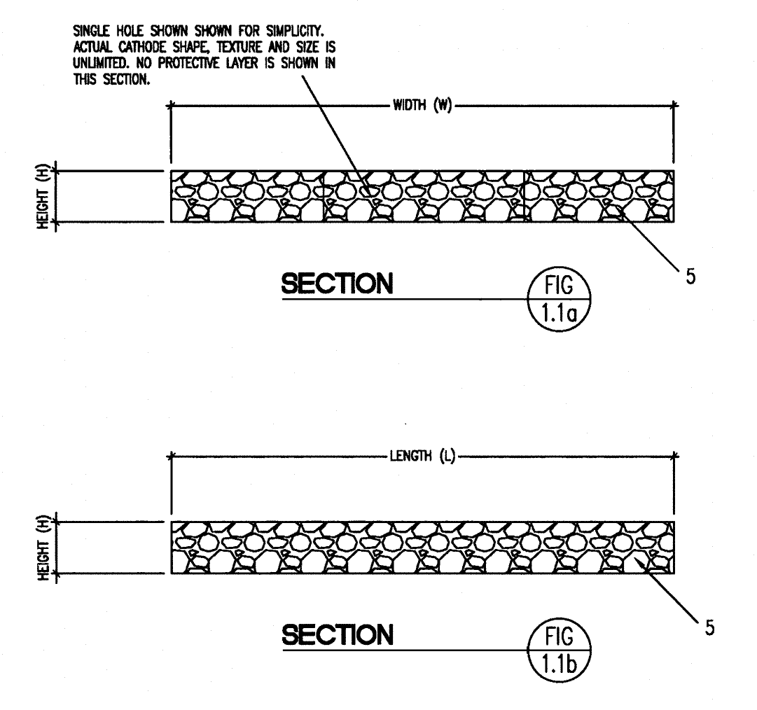

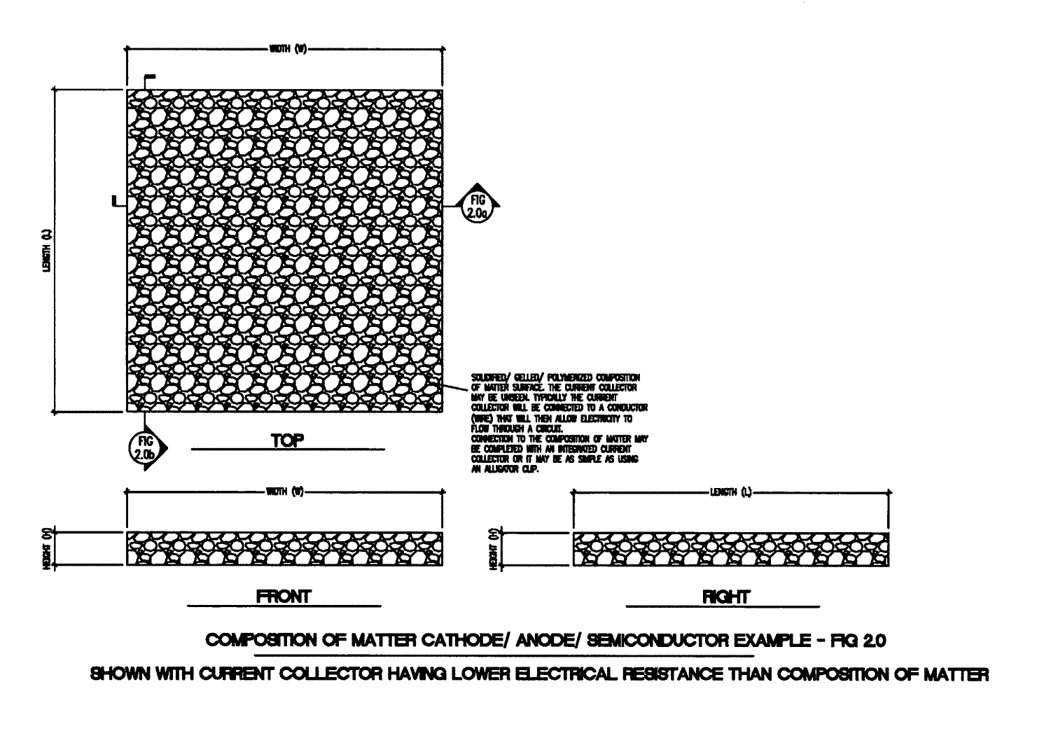

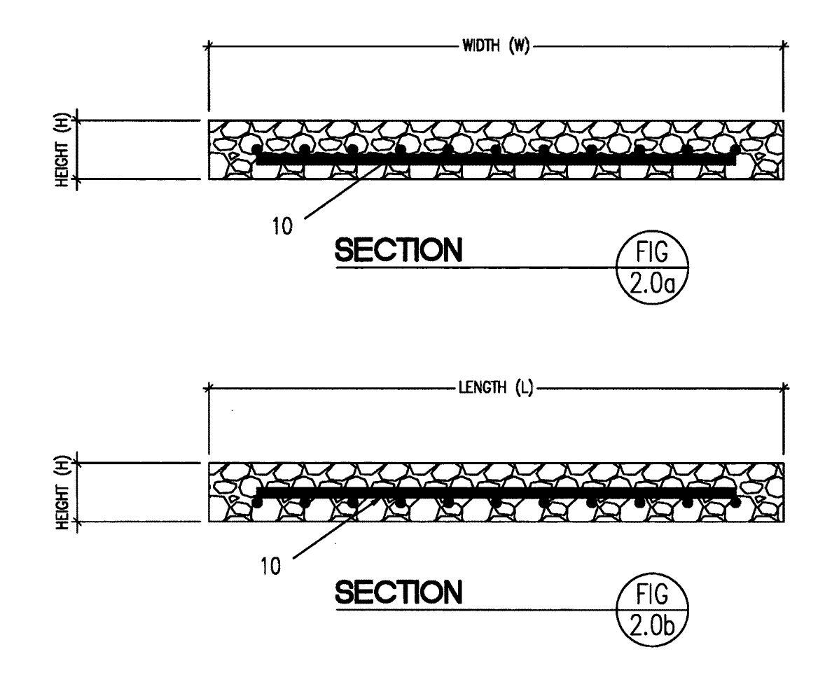

The fourth embodiment is a modified version of the first embodiment that provides a current collector, as shown in FIG. 2.0, FIG. 2.0a, and FIG. 2.0b, as well as other figures included. The current collector depicted in those figures integrates into the composition of matter and solid design. Current collectors may also serve to reinforce the composition structurally. Graphite/Carbon fiber current collectors perform well. Similar to concrete industry studies on steel rusting, cover over metal current collectors significantly slows corrosion processes.

The current collector can be wire, surface or solid. Copper wire is a simple example. The composition of matter described in embodiment one has a high conductivity at low binder ratios, typically not needing current collectors, and it should be noted that it can serve as a conductor as well as a cathode/anode electrode.

Graphite based/conductive non-porous organic polymer coatings on metallic current collectors significantly slows corrosion issues.

As shown in FIGS. 2.0c, 3.1a, 3.1b, the current collector can easily be manipulated. An alligator clip or screw clamp attached to a composition may be considered a current collector.

### Fifth Embodiment

### Layers

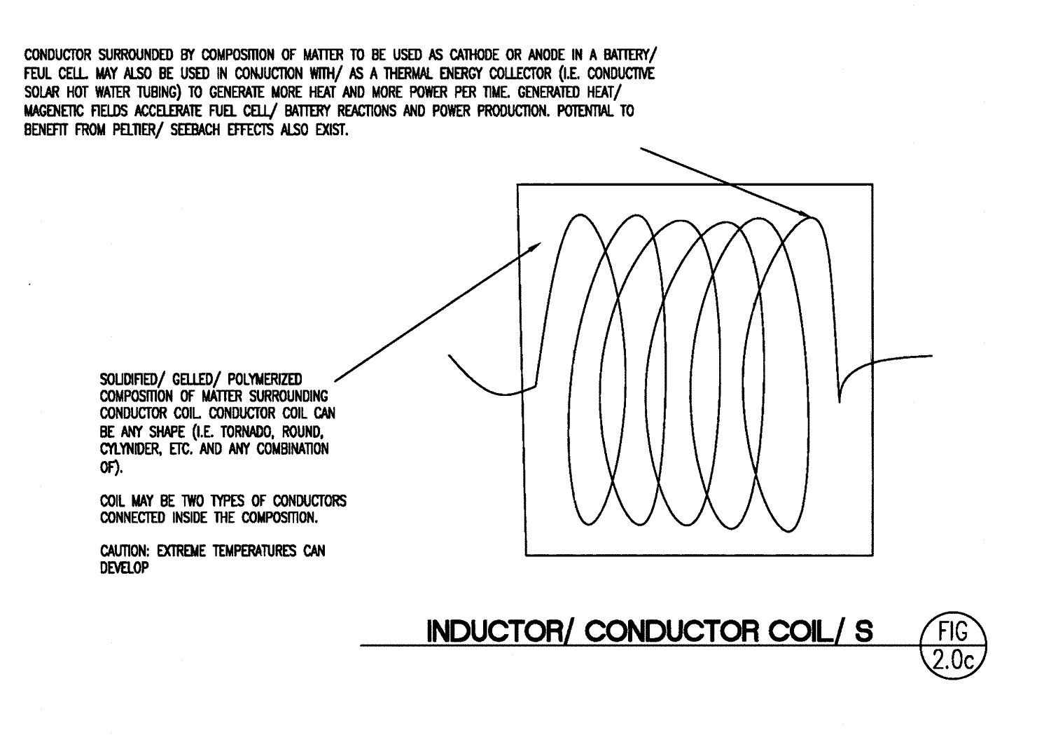

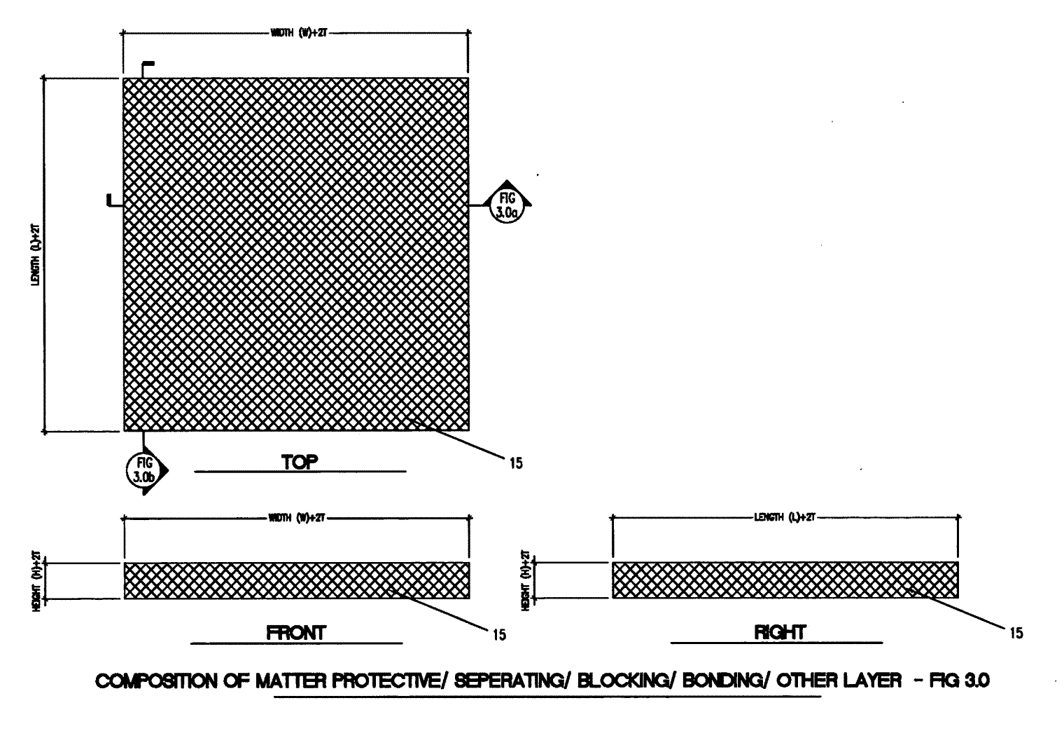

The fifth embodiment includes a sealant, protective, or other layer onto a composition of matter as depicted in FIGS. 3.0, 3.0a, 3.0b, 3.1, 3.1a, and 3.1b. The layer may operate as a protective, separating, blocking, and/or bonding layer, and may be conductive or nonconductive. The layer may or may not be composed of a cement based material and may or may not be composed of graphite or carbon. It may or may not be chemically adhered. Paper, cardboard, dirt, space and much more can serve the purpose of a separation layer. The layer may be permeable to ionic flow, or non-permeable to ionic flow. It can filter ionic flows. The layer may serve to protect from extreme heat and/or chemical environments.

The layer may also contain “catalysts or other additives” to promote desired reactions. As an example: cobalt has shown to work very well with aluminum chloride based rechargeable aluminum ion batteries using the composition of matter as the positive cathode electrode and aluminum as the negative anode electrode. Significant research exists for photovoltaic catalysts. Titanium dioxide is an example of a catalyst.

The thickness of any given layer may be very thin. Although catalysts such as cobalt, gold, rhodium, and platinum are very expensive, extremely thin layers “doped” with the catalysts are able to cover much greater areas than if the catalyst was included into the “core” or “base” composition of matter.

Parts of a base or core composition may be layered differently than the rest of its parts. As an example. An impermeable sealant could surround most of a solid state battery cell, but a section could be modified to allow adding electrolytes as needed.

Variance in the mix design of the cathode and the protective, separating, blocking, or bonding layers significantly influences properties including structural strength, durability, cathodic or anodic potential, currents, band gaps, other electrical & magnetic properties, ability to clean/maintain, future repairability, porosity, multi-layer binding strength, and infinite other properties that may or may not be desired.

Layering or molding systems can be used to direct fuel and waste streams in fuel cells much easier than methods that currently exist. In addition the composition of matter may be used for testing purposes when final designs use more expensive materials.

The ability to layer the systems, very similar to how plaster and stucco are used, make this invention and the compositions of matter very unique.

### Sixth Embodiment

### Fuel Cell/Battery Applications

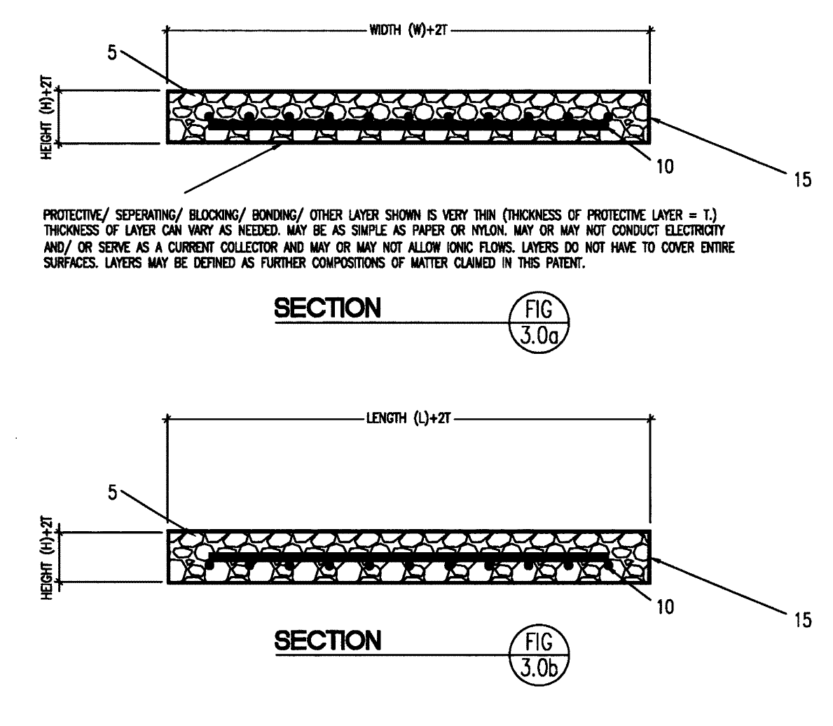

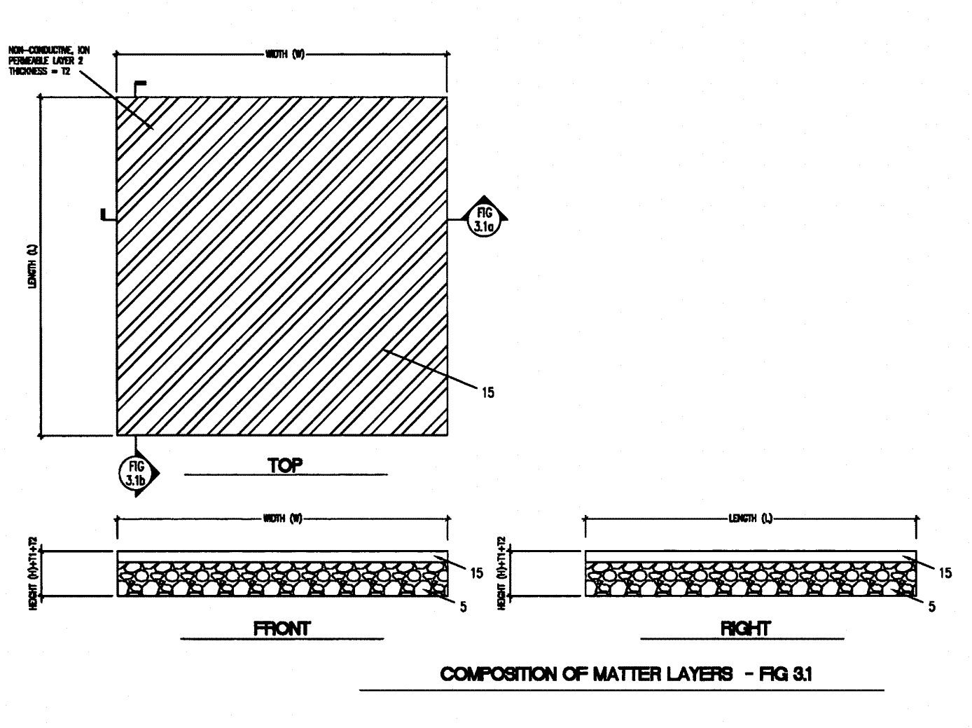

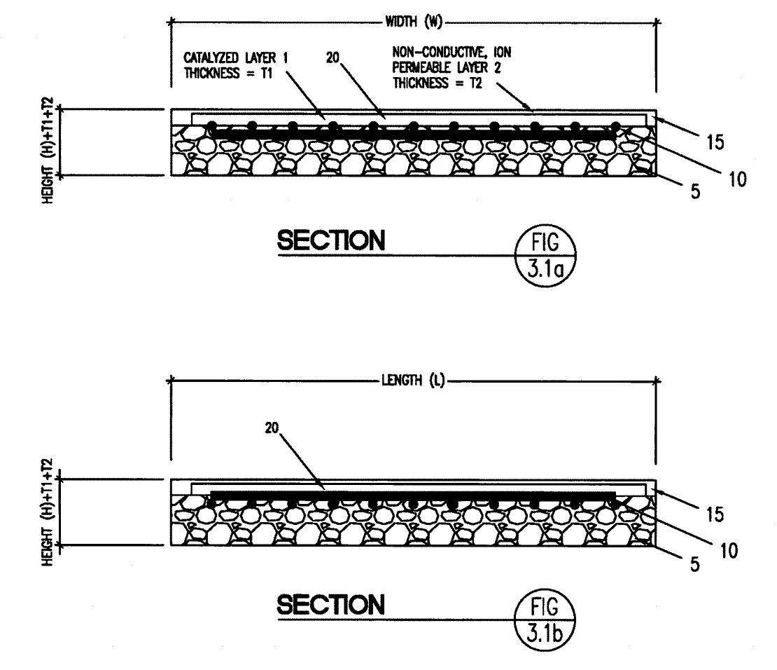

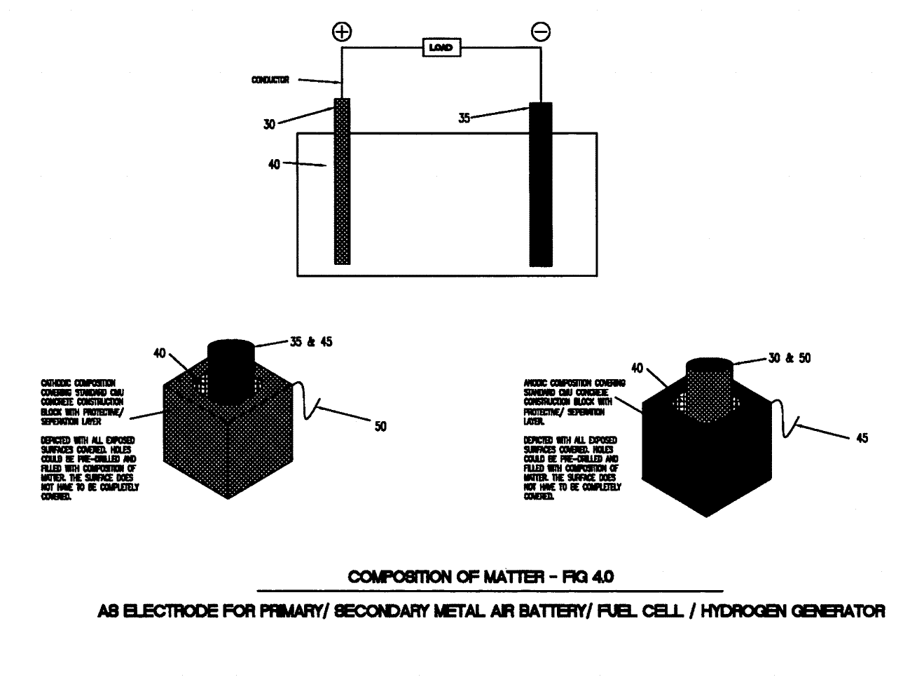

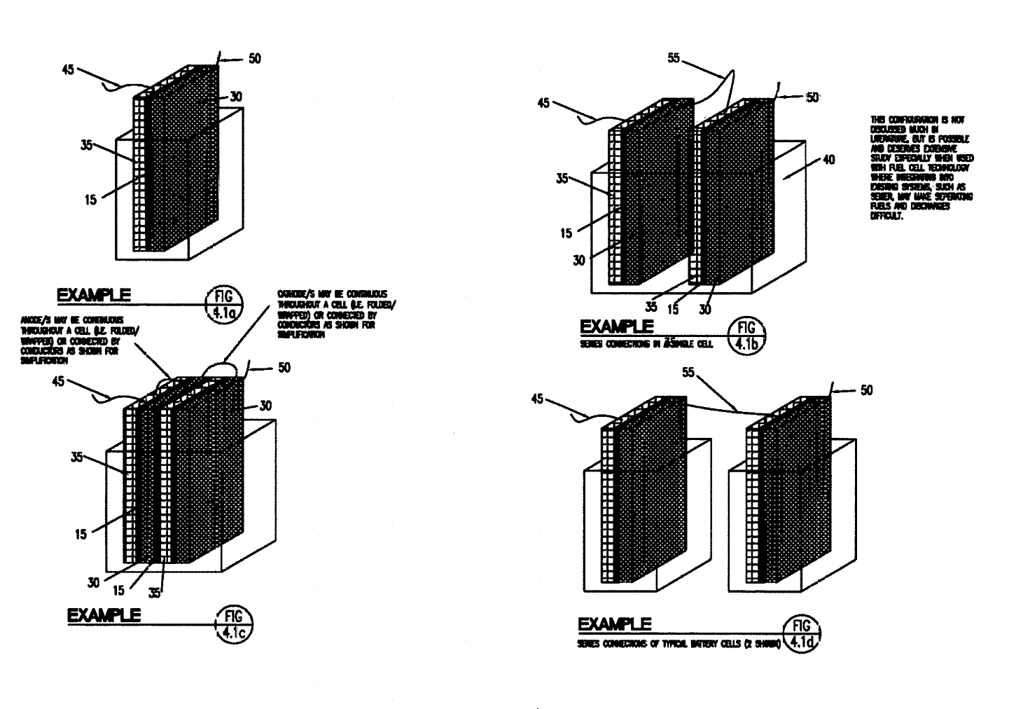

The sixth embodiment teaches the composition of matter being utilized as a fuel cell/battery. Referencing FIG. 4.0, a cathode (30) and an anode (35) are ionically connected by an electrolyte (40). The composition of matter (5) can be utilized as a cathode or anode depending on the intended design. For sake of example, the composition of matter will be used as a cathode, aluminum foil as anode and a sodium hydroxide water solution is used to make a powerful aluminum air battery. If the aluminum is replaced with steel, an iron alloy air battery is made. Graphite is the most noble substance known to exist and most metals as well as many fluids, solids, powders and even dirt can take the place of anode if a current collector, such as carbon powder is used.

Referencing FIG. 4.1a, the cathode (30) and anode (35) are divided by a separation layer (15). The separation layer ensures the anode and cathode are not conductively touching. The layer may be paper, electrolyte filled space, dirt, engineered synthetic zeolites, engineered filter systems, or any other method of ensuring electrical current can not pass from cathode to anode. For solid cell applications the layer may use the cementing parts of the composition of matter without conductive fillers or graphite. Fillers that modify/filter ionic flows can be developed for intended use. A positive terminal (50) stems off the cathode (30) layer and a negative terminal (45) stems off the anode (35) layer.

Considering the abundance of aluminum and other anodic materials in the earth's crust there exists the possibility of very large anodes and very large scale cathodes. Landfills could also use different compositions of matter covered under this patent as well as utilize many different shapes and current collection methods. Recycling waste products from metal batteries is not much different than recycling without using the stored energy.

It has been found that most soils and rocks contain anodic substances and when mixed into an invented composition of matter or used as an electrolyte with current collection integrated through the soil matrix, there is electric potential and currents generated. Aluminum and other metals are abundant in the earth's crust and in our water supplies. In addition to the inorganic anodic materials and compounds/alloys, there are bio and organic substances (some still living), photo & heat catalyzed/sensitive substances, and more.

The present composition of matter can be used as a cathode or anode, in many different configurations, depending on additives and chosen design. Primary and secondary batteries are an example. Fuel cells, bio batteries, microbial fuel cells, and more can take advantage of using the patented composition of matter.

The composition of matter may easily be shaped or coated onto substrates including, but not limited to concrete, metal, wood, pvc, glass, and other films or composites. During mixing and forming/applying the composition, workability is controlled by mix design.

Accepted concrete industry and battery practices are the baseline. The unique ability to carefully control the internal structure of electrodes is one of this invention's defining characteristics and opens the door for a new science integrating concrete with battery/fuel cell/energy systems.

The composition of matter opens the door to a world that is literally built with and on batteries and fuel cells. Structures, roads, sidewalks, driveways, walls, trash cans, drainage ditches, and so much more can easily become part of battery/fuel cell thermal energy systems. The ability to store tremendous amounts of electricity without the enormous costs associated with current battery technology is a unique quality of this discovery.

A home's trash aluminum may power outdoor lighting, or 5 small cathodes may be all that's needed to charge your phone, as long as you have aluminum or other anodic metals, electrolyte and necessary wiring. Remote areas where electricity may be needed can design batteries/fuel cells to last as long as needed even in unstable environments.

### Seventh Embodiment

### Disclosures on the Possible Uses of the Composition

This eighth embodiment discloses the use of the presently described composition of matter for thermal energy transfer, solar energy applications, transporting electrical energy, more applications, and their combinations.

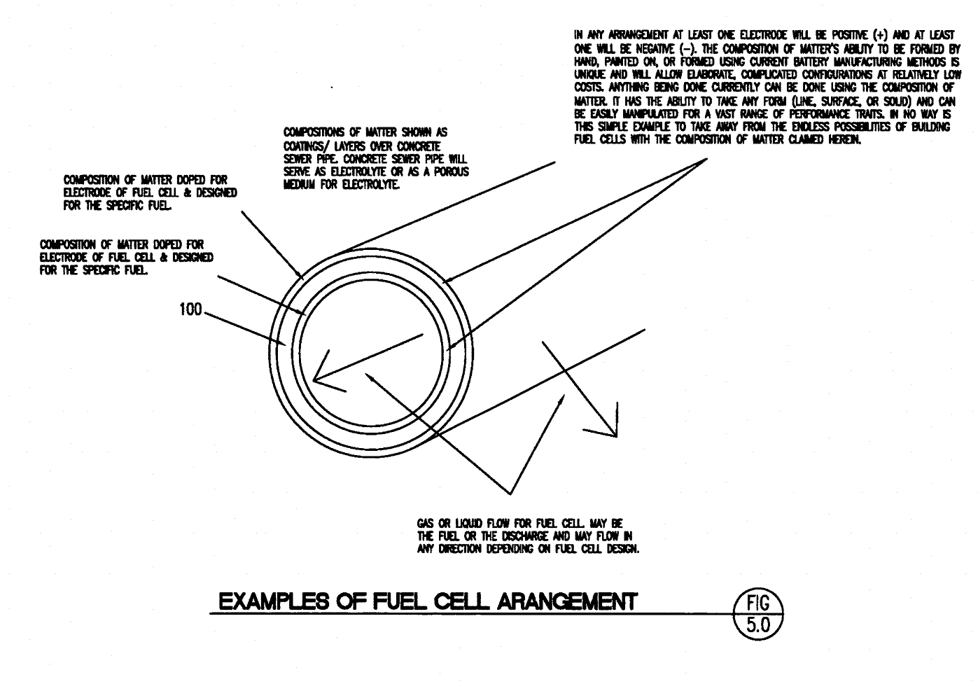

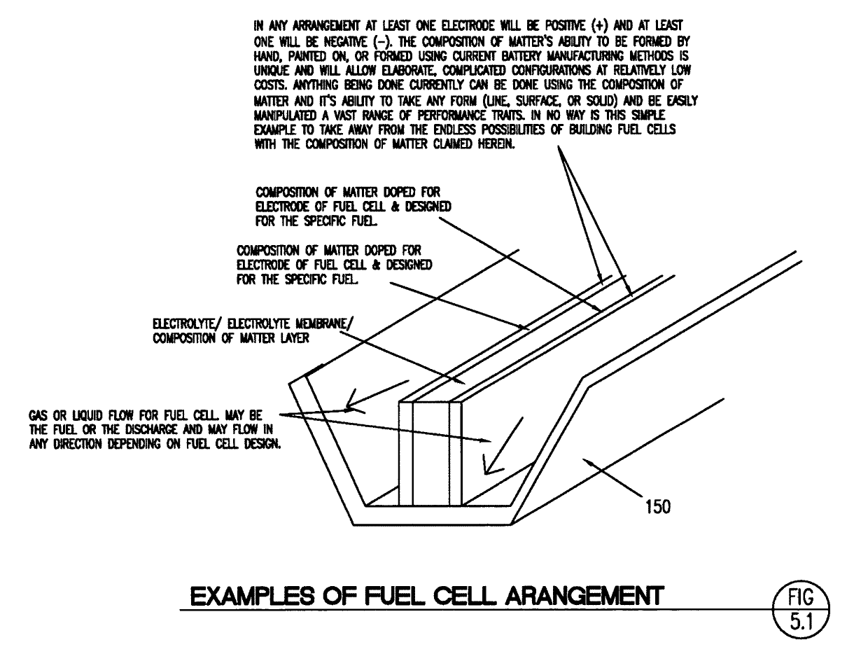

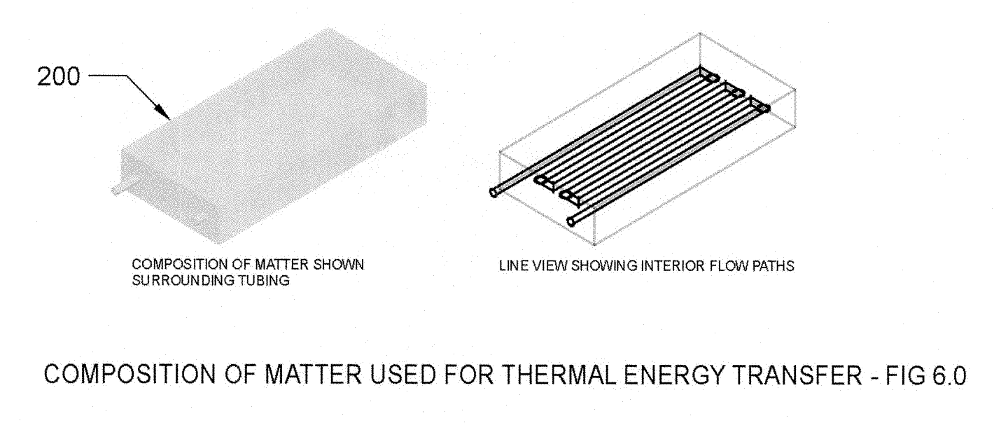

The composition of matter may have multiple uses packaged into one unit. For example, the tubing shown in FIG. 6.0 could be used to transport fluid or gas for thermal energy transfer from the graphite based solid exposed to sunlight or possibly to extreme temperatures from metal castings. The fluid transport lines also can serve as current collectors for a large composition of matter being used as a fuel cell while absorbing the sun's energy. Fuel cells often generate electricity at higher rates in high heat environments. A hot water producing battery. A superheated fluid waste energy recovery graphite mold for metal casting. Either can be made exactly the same way. Simply use the composition as a conductor for the battery system and you have another use of the composition discovered being a part of one overall energy system.

Again referencing FIG. 6.0, flow paths may be cast or shaped with or without a physical tubing of different composition, and the term “tubing” is not meant to refer to a shape or sized, but rather a path for fluid or gas flow. Tubing may be conductive and serve as part of or the entire current collector such as using copper tubing or perhaps gold plated copper. The tubing may also serve as an anode or as a cathode. The tubing may be of a different material within the composition with internal connections designed for desired traits such as conductivity breaks or polymer protective coatings where corrosion is likely. When analyzing a porous composition of matter, the nano structure that allows fluid or gas flow should be assumed to be “tubing.” Layering over tubing makes cathode and anode separation possible.

The thermal energy transfer may be a heat gain or a heat loss, depending on the intended use and design. An example of use would be a hot water heater & battery cathode, or a fuel cell “fuel” pre-heater/cooler. These are two simple examples. Current concentrated solar systems often use molten salts to transport and store thermal energy. The composition of matter is extremely heat resistant and with a proper mix design can compete with any known materials currently being used for molten salt transport, and storage.

For thermal energy harvesting the additives may serve to enhance properties desired for such applications.

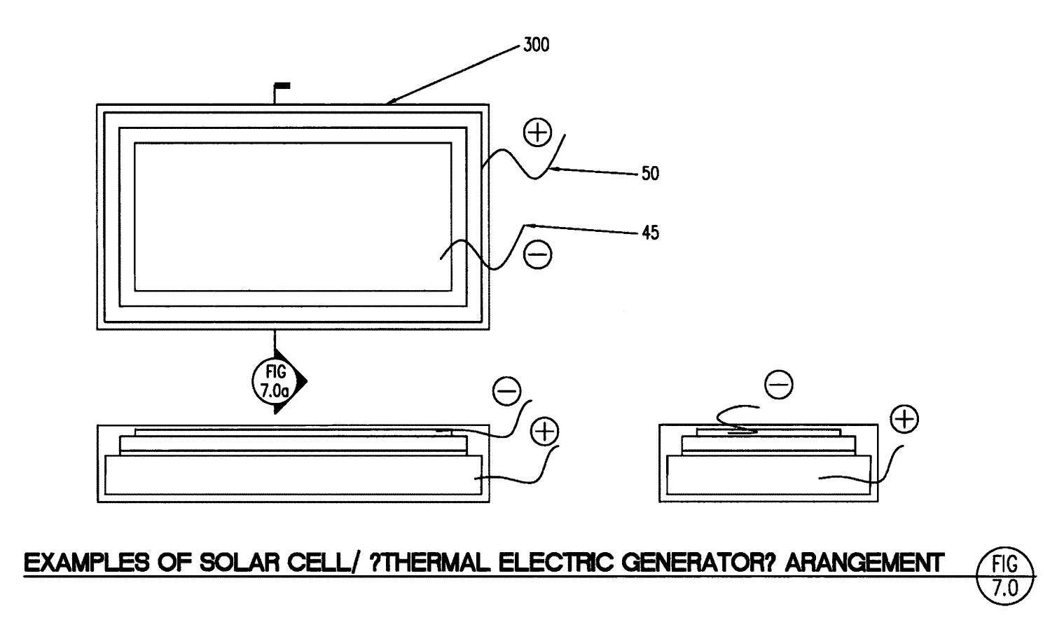

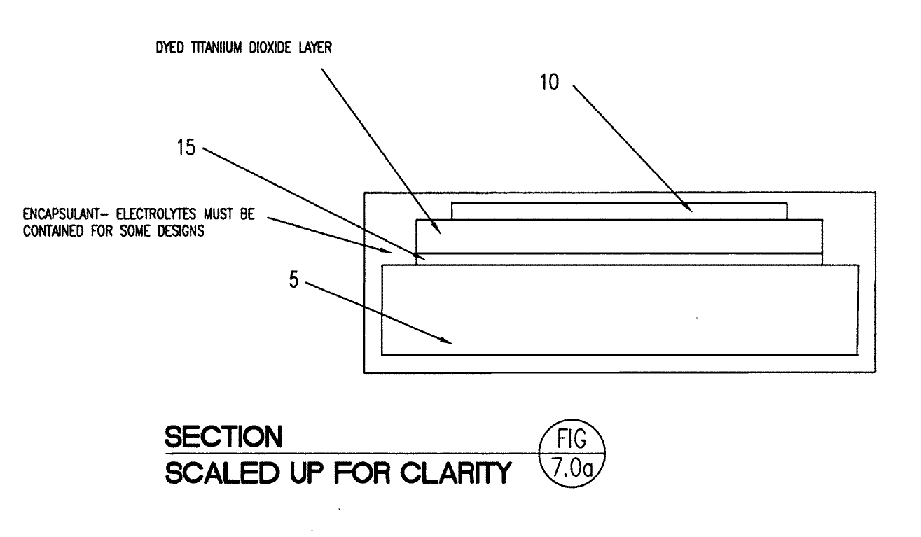

The composition of matter can be used for solar/photovoltaic electric generation and an example cell design is shown in FIGS. 7.0 and 7.0a.

The graphite electrodes made using the discovered composition form a conducting and catalytic counter electrode for dye-sensitized solar cells. Solar cells may or may not rely on an encapsulated electrolyte as shown in the figures. The surface encapsulating the electrolyte must allow light to transmit and for some designs will be required to be impermeable to gases and liquids. Standard silicon solar cell encapsulates work well. Doped glass coatings, and organic sealant systems are examples of compositions that can be integrated with the invention. Many current concrete industry sealants can be doped with catalysts and with a minimal amount of “ultra-fine” graphite. This forms transparent, conductive, catalyzed layer for photon capture. In addition metallic current collection wires/ribbons, separate from those in the counter electrode may be used in the transparent photo absorbing/catalyzed layer.

The composition of matter performs well in all known graphite and carbon applications. The mix can be designed thin to behave like ink and paint or it can formulated to be the consistency of clay and concrete. Depending on the intended use, the chemical composition and heat resistance, as well as the structural properties of the solidified composition can easily be altered. This allows the composition to be used for fire proof coatings, foundry coatings, fire brick, graphite crucibles, and much more. Any prior arts making use of graphite or carbon may find this discovery helpful.

1. The invention claims the composition of matter as described in the detailed description embodiments.

2. The invention claims the mix designs and legal rights to pre mixed materials for manufacturing/mixing the composition of matter.

3. The invention claims the electrical, thermal energy systems and other functional goods created using the discovered composition.
